(19) United States
(12) Patent Application Publication
(10) Pub. No.: US 2008/0273495 A1
(43) Pub. Date: Nov. 6, 2008

(54) Smooth Handover in a Wireless Local Area Network

(76) Inventors: Thomas Becker, Berlin (DE); Frank-Michael Krause, Berlin (DE); Michael Methfessel, Frankfurt (Oder) (DE); Klaus Tittelbach-Helmrich, Frankfurt (Oder) (DE); Andrew Stuart Lunn, Othmarsingen (CH)

Correspondence Address: CHRISTIE, PARKER & HALE, LLP, PO BOX 7068, PASADENA, CA, 91109-7068, US

(21) Appl. No.: 11/597,845

(22) PCT Filed: May 26, 2005
(86) PCT No.: PCT/DE05/00974

§ 371 Date: May 19, 2008

(30) Foreign Application Priority Data
May 27, 2004 (DE) 10 2004 026 495.3

(51) Int. Cl. H04Q 7/00; H04Q 7/20

(52) U.S. Cl. 370/331; 370/330; 455/442

(57) ABSTRACT

A process for operation of a data link transmitting data packets between a base station and one or more mobile stations within transmission phases. A start signal indicates the start of each transmission phase that is managed by the base station. For preparation of a handover procedure the mobile station switches into a monitoring phase, wherein the radio traffic is listened to and another base station suitable for the data packet transmission is sought. The mobile station performs data packet transmission in every m^{th} transmission phase, “m” designating a natural number greater than “1”, and after data packet transmission has been effected, the mobile station is omitted from the data packet transmission for at least one subsequent transmission phase.

### CROSS-REFERENCE TO A RELATED APPLICATION

This application is a National Phase Patent Application of International Patent Application Number PCT/EP2005/000974, filed on May 26, 2005, which claims priority of German Patent Application Number 10 2004 026 495.3, filed on May 27, 2004, the entire contents of both of which are incorporated by reference.

### BACKGROUND

A process for operating of a data link between a base station and one or several mobile stations is for example known from Wireless Local Area Network (WLAN) systems. In this previously known process, a data link between a base station and one or several mobile stations is operated in that data packets are transmitted between the base station and the mobile stations within transmission phases. In WLAN systems, the transmission phases can be constituted by “contention-free” periods. The start of each transmission phase is indicated each time by the emission of a start signal, which clearly can also be described as a beacon signal; after the emission of the beacon signal, the air interface between the base station and the mobile stations for the transmission phase in question is reserved or managed by the base station. Within each transmission phase, the mobile stations are addressed by the base station and called up for the exchange of data packets. Each time after the completion of each transmission phase, there follows a trans-mission pause, in which no transmission of data packets controlled or managed by the base station takes place between the base station and the mobile stations. Since in these transmission pauses the air interface is not managed by the base station, any other devices can gain access to the air interface in these transmission pauses. Accordingly, in WLAN links, these transmission pauses are also described as “contention” periods. In WLAN networks, the sending of the beacon signals by the base station takes place at regular time intervals, for example every 10.24 ms, so that a new transmission phase is created every 10.24 ms.

Newer WLAN systems, for example those on the IEEE 802.11e standard, offer the possibility of guaranteeing a quality of service (QoS). This is achieved in that the WLAN base station, usually also described as access point or briefly as “AP”, allocates the necessary bandwidths to the mobile stations assigned to it by means of a time multiplexing process. This QoS support makes it possible to obtain telephony with the quality of existing Digital European Cordless Telephone (DECT) systems via WLAN, so long as the mobile station in question remains linked with the same base station. The QoS support itself is linearly based on the hybrid coordination function (HCF) of the 802.11e standard.

The problem arises with processes of this type that a mobile station possibly changes it base station, i.e. has to switch from the original base station to another base station, for example if the transmission quality (e.g. signal strength, signal to noise ratio, bit error rate, etc.) in relation to the original base station has deteriorated. This is known as a handover procedure. The transmission quality should not, or at least not significantly, be impaired during the handover procedures, so that the handover procedure is as far as possible imperceptible to the user of the link, for example, in the case of a telephone link, to those having the telephone conversation.

EP 1,398,912 A1 discloses a system for carrying out handover procedures (known as a roaming system), with which a mobile station can be switched from one base station to another base station, without an interruption in communication between the mobile station and the base stations. This is achieved in that the mobile station performs either an active searching operation on completion of a transmission phase formed by a contention-free period, in which the transmission quality to other base stations is determined actively by sending a sample signal, or a passive searching operation, during which signals from other base stations are monitored passively either after a transmission phase or, if the mobile terminal does not communicate during a transmission phase, also during a transmission phase.

In EP 1,398,912 A1, the search for other base stations therefore takes place predominantly outside the regularly provided transmission phases, in particular in the pauses between two transmission phases between two successive beacon signals. During the active searching operation, it is necessary to send a separate probe signal, by means of which the transmission quality to the other mobile station is determined.

U.S. patent application No. 2002/0191561 A1 discloses a process and a device which allow a handover of a mobile station from a first subnetwork to a second subnetwork by means of addresses known as shadow addresses, in a wireless communications system.

### SUMMARY

Embodiments of the present invention provide a process which makes it possible for mobile stations to be able to carry out seamless handover procedures to other base stations.

According to the embodiments of the present invention, each mobile station performs data packet transmission exclusively in every m^{th} transmission phase, “m” designating a natural number greater than “1” and, after data packet transmission has been effected, is omitted from the data packet transmission for at least one subsequent transmission phase. If the mobile stations wish to prepare for a handover procedure, they switch into a monitoring phase outside the transmission phases used for the data packet transmission with the base station. In this monitoring phase, the radio traffic, in particular at other frequencies than the transmission frequency of the assigned base station, is listened to, and another (new) base station suitable for the data package transmission is sought.

According to one aspect of the invention, during this, time windows are deliberately created for the mobile stations, wherein the mobile stations can prepare for a handover procedure if required. This is achieved according to the invention through the fact that each mobile station does not have to transmit data packets in every one of the transmission phases “made available” by the base station, but instead of this is regularly “released” for at least one transmission phase.

Through the deliberate omission of transmission phases, a free time space is created, in which the mobile stations can monitor the radio traffic at other frequencies and can seek other base stations, better suited for the data transmission.

A further aspect of the process according to the embodiments of the invention can be seen in that the process enables a quasi interruption-free handover procedure with all real-time critical data streams, in particular for example with audio (e.g. audio data formed in accordance with the DECT standard) or video data streams which are transmitted via WLAN.

In one embodiment, a transmission pause, in which no data packet transfer for useful data transmission takes place, follows each transmission phase each time.

In one embodiment, in the event of the availability of another suitable base station, the mobile station sets up a parallel link with the other base station for the preparation of the handover procedure, during which time windows which lie outside the transmission phases used for the data packet transfer with the original base station are used for the parallel link. Through the formation of an interim parallel link, it is ensured that a loss of data packets during the handover procedure is avoided.

In one embodiment, the two base stations operate with different transmission frequencies. The beacon signals of the two base stations can be mutually asynchronous. In one embodiment, the beacon signals of both stations are made equidistant each time.

The process can for example be carried out according to the WLAN standard described at the outset; the base stations are accordingly each constituted by WLAN access points (APs). After the emission of the beacon signals, the air interface for the frequency range in question is thus reserved each time with the creation of a “contention-free” period; between the transmission phases, the air interface in the frequency range in question is released for “contention” periods. The end of each transmission phase can for example be indicated each time by the emission of a “contention-free end signal” by the base station.

According to the embodiments of the invention it is provided for the omission or the use of the transmission phases to take place continuously such that each mobile station performs a data packet transmission exclusively in every m^{th} transmission phase, where “m” denotes a natural number greater than 1. In one embodiment each mobile station performs a data packet transmission in every second transmission phase.

The time windows used for the parallel link in one embodiment include those transmission phases of the original base station which are omitted with respect to this base station.

In one embodiment, after the link has been effected with the other base station, the parallel link with the original base station is ended, in order to take the load off the air interface.

In one embodiment, if several mobile stations are connected to the base station, the assignment of the mobile stations to the transmission phases which are used for the data packet transmission with the base station in question is effected evenly. For example, half of the mobile stations are enlisted for data packet transmission in all “odd” (first, third, fifth, etc.) transmission phases, and the other half of the mobile stations in all “even” (second, fourth, sixth, etc.) transmission phases. Accordingly, each time the data packets should be “bundled” or formed such that, in spite of the use of only every second transmission phase, at the receiving end an uninterrupted, data loss-free received data flow can be formed; hence if only every second transmission phase is used, then the data packets must be twice as large or contain twice as much useful data as would be necessary with a data packet transmission in every transmission phase.

In one embodiment, the time interval between two consecutive beacon signals is selected to be at least twice as large as the length of the contention-free periods lying between them each time, if every “second” transmission phase is omitted by the mobile stations each time. In one embodiment, the duration of the monitoring phase of the mobile stations is at least 1.5 times the time interval between two consecutive beacon signals.

The time interval between two beacon signals can for example be between 5 ms and 15 ms; with WLAN links an interval of 10.24 ms is for example selected.

The invention further relates to a base station for the operation of a data link with one or several mobile stations.

With respect to such a base station, the embodiments of the invention make it possible for the assigned mobile stations to be able to carry out handover procedures to other base stations as seamlessly as possible.

According to the embodiments of the invention a base station is used for the operation of a data link between a base station and one or several mobile stations, wherein the base station has a base station control device which is configured such that it exchanges data packets with the mobile stations within transmission phases. According to the embodiments of the invention, the base station is characterised in that it assigns the transmission phases to the mobile stations in such a manner that each mobile station performs data packet transmission exclusively in every m^{th} transmission phase, “m” designating a natural number greater than “1”, and each time after data packet transmission has been effected remains excluded from the data packet transmission for at least one subsequent transmission phase.

The base station according to the embodiments of the invention, reference is made to the above explanations in connection with the process according to the embodiments of the invention.

The invention further relates to a mobile station for the operation of a data link with a base station.

With respect to such a mobile station, the embodiments of the invention is make it possible for this to be able to carry out handover procedures to other base stations as seamlessly as possible.

The embodiments of the invention use a mobile station for the operation of a data link with a base station, wherein the mobile station has a mobile station control device which is configured such that
it exchanges data packets with the base station within transmission phases, and
outside the transmission phases used for the data packet transmission with the base station it switches for the preparation of a handover procedure into a monitoring phase in which the radio traffic is listened to, and another base station suitable for the data packet transmission is sought.

According to the embodiments of the invention it is provided that the mobile station control device
performs data packet transmission exclusively in every m^{th} transmission phase, “m” designating a natural number greater than “1”, and
each time after data packet transmission has been effected, omits at least one subsequent transmission phase for data packet transmission.

With regard to the aspects of the mobile station according to the invention and with regard to various embodiments of the mobile station according to the invention, reference is made to the above explanations in connection with the process according to the invention.

### BRIEF DESCRIPTION OF THE DRAWINGS

The invention is further explained with reference to the figures.

FIG. 1 shows a network with eleven mobile stations according to the invention and three base stations according to the invention, and the process according to the invention is illustrated on the basis of the network.

FIG. 2 shows the course of transmission before a handover procedure.

FIG. 3 shows the course of transmission during a handover procedure.

FIG. 4 shows the course of transmission after a handover procedure.

FIG. 5 shows a transmission procedure in detail.

### DETAILED DESCRIPTION

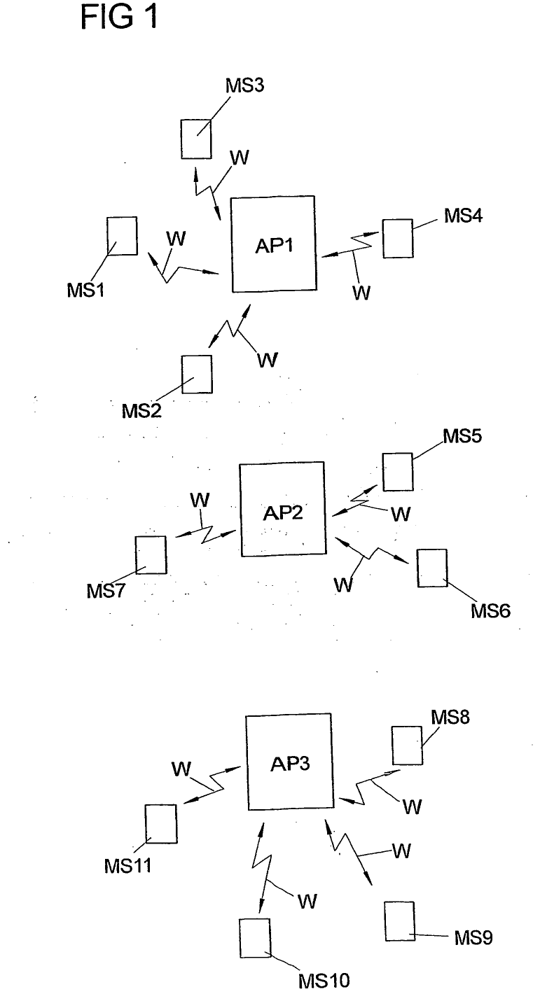

In FIG. 1, four mobile stations MS1 to MS4 are seen, which are in a WLAN radio link W with an access point AP1. Correspondingly, three mobile stations MS5 to MS7 are in a WLAN radio link W with an access point AP2, and four mobile stations MS8 to MS11 with an access point AP3. The WLAN radio link W can for example be effected in accordance with the standard IEEE 802.11 a, b or g with HCF-QOS extensions in accordance with IEEE 802.11e.

If for example the signal quality in the data link between the mobile station MS2 and the access point AP1 decreases, then the mobile station MS2 must seek another access point with better transmission quality and create a link with this. Since different frequencies are assigned to different access points, the mobile station MS2 must retune on a trial basis to another frequency, wait for a beacon on this frequency and, if one is found, record the associated signal quality, for example the signal strength. By repetition of this “scan procedure” at different frequencies, a table of possible access points is built up, in order then to seek the optimal access point as the target of the handover.

A problem now is that the access points AP1 to AP3, in contrast for example to DECT base stations, are not mutually synchronised. The beacons (short for beacon signals) of the different access points are thus in any time position relative to one another, although they each display the same beacon repeat rate. For example, the transmission phases of the access points AP1 to AP3 may overlap.

Since the mobile station MS2 cannot know the time shift of the beacon signals, it must, with a beacon signal interval of for example 10.24 msecs, listen at the given new frequency for at least approximately 10 msecs in order to intercept a possible beacon signal. This could lead to an interruption in the data stream, since in the period in which the mobile station MS2 is tuned to another frequency no data can be transmitted to the old, original access point AP1.

In order to prevent such an interruption of the data stream, each access point AP1 to AP3 divides the transmission phases in such a manner that each assigned mobile station omits at least one transmission phase each time after each utilised transmission phase. For example, each mobile station sends and receives data packets only in every second period.

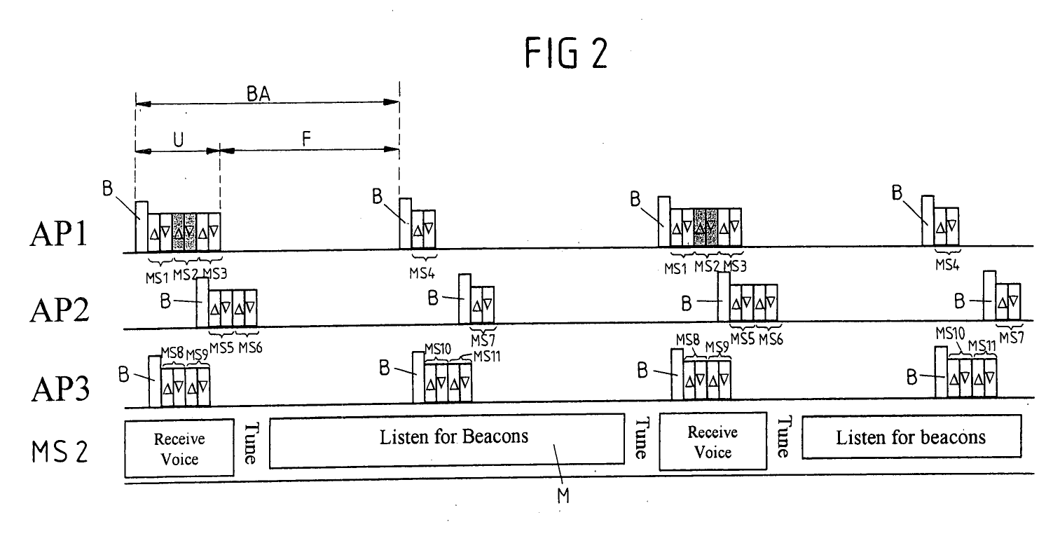

This is shown by way of example in FIG. 2, in which the time sequence of the data packet transmission between the access points AP1 to AP3 and the mobile stations MS1 to MS11 is shown. In each case, a “A” symbol represents a transmission in the mobile station direction and the symbol rotated through 180° a transmission in the access point direction. The beacon signals are marked with the symbol B and have a beacon interval of for example 10.24 msecs.

The transmission phase, or “contention-free period”, triggered by the beacon signal B is marked in FIG. 2 with the symbol U. Each transmission phase U is followed each time by a transmission pause F (“contention period”), in which the air path is released for the frequency range in question.

Since each mobile station MS1 to MS11 each uses only every second transmission phase, the quantity of data per transmission phase each time is doubled, compared to a “normal” transmission in every transmission phase, in order to obtain the required mean data rate.

As can be seen in FIG. 2, in one embodiment, the mobile stations assigned to each access point are evenly apportioned to the “even” and “odd” beacons or transmission phases, in order to attain an even loading of the transmission phases.

Since only every second transmission phase relative to the access point AP1 is used, the mobile station MS2 has sufficient time between the data transmissions to the assigned access point AP1 to retune to another frequency, to seek a beacon there, and tune back to the old frequency in good time. The central point is that the beacon period is still always 10.24 msecs, although the interval between the transmission phases actually used is doubled, compared to the “normal” use of all transmission phases.

In one embodiment, the time interval each time between two consecutive beacon signals, here 10.24 msecs, is at least twice as large as the length of the contention-free period U lying between them; this means that the transmission phases may last a maximum of 5.12 msecs each time. Correspondingly, the duration of the monitoring phase M of the mobile station MS2 can be 1.5 times the time interval between two consecutive beacon signals, i.e. approximately 15 msecs. Accordingly, in this monitoring phase of 15 msecs at least one beacon on the new frequency must be recognisable, irrespective of how the beacons of the three unsynchronised access points AP1 to AP3 are displaced relative to one another, because the beacon interval at all access points is 10.24 msecs in each case.

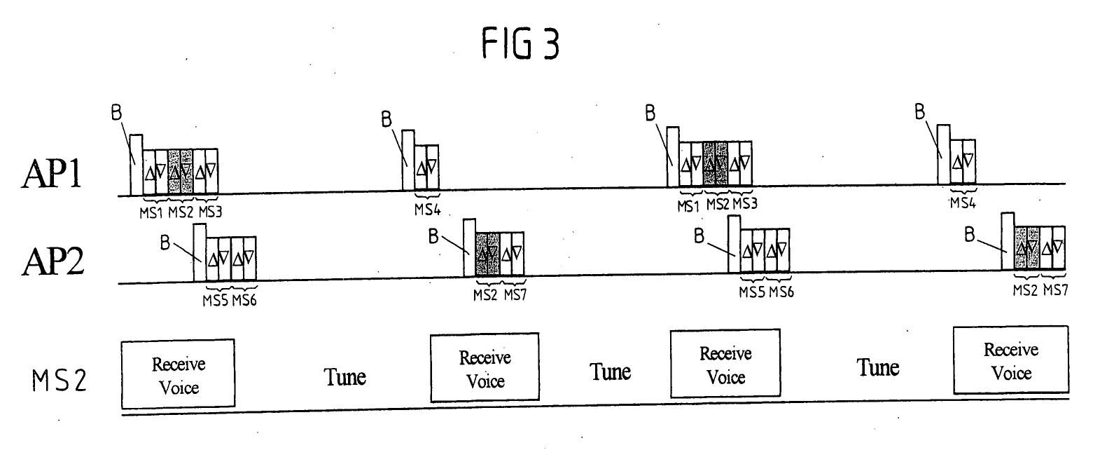

If, as already mentioned above in connection with FIG. 1, for example the signal quality in the data link between the mobile station MS2 and the access point AP1 decreases, then the mobile station MS2 scans the air interface at different frequencies for available access points. If for example in the process it is established that the access point AP2 is suitable for a handover procedure, then the mobile station MS2 will set up a parallel data link with the new access point AP2. This is shown in detail in FIG. 3.

As can be seen in FIG. 3, the assignment to the “even” or “odd” beacon at the new frequency of the new access point AP2 is selected in such a manner that in fact two parallel data streams are possible; this means for example that the mobile station MS2 must select an “odd” transmission phase in relation to the new access point AP2, if it is in an “even” transmission phase in relation to the old, original access point AP1. In the handover phase, the mobile station MS2 on average transmits data every 10.24 msecs, which are alternately directed to the old and the new access point.

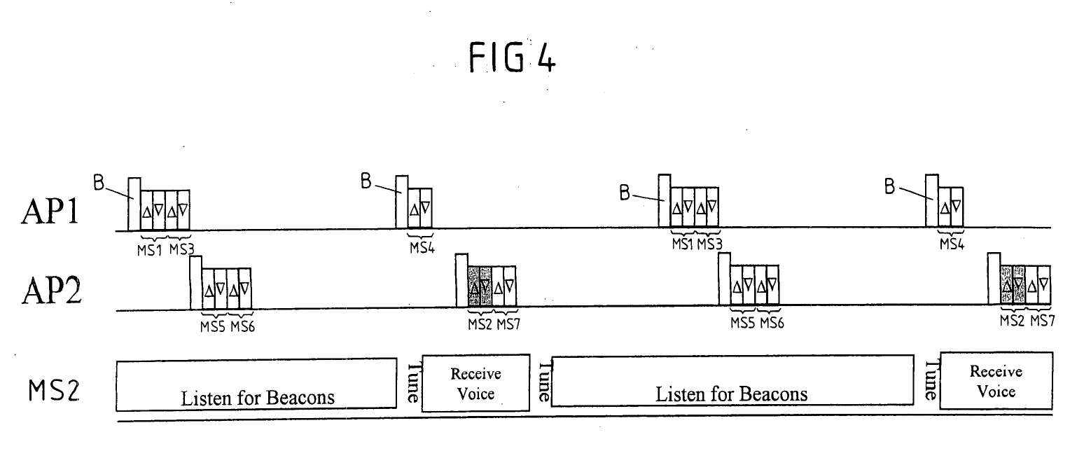

As soon as the creation of the parallel data link is completed, the link to the original access point AP1 is broken off; this is shown in FIG. 4.

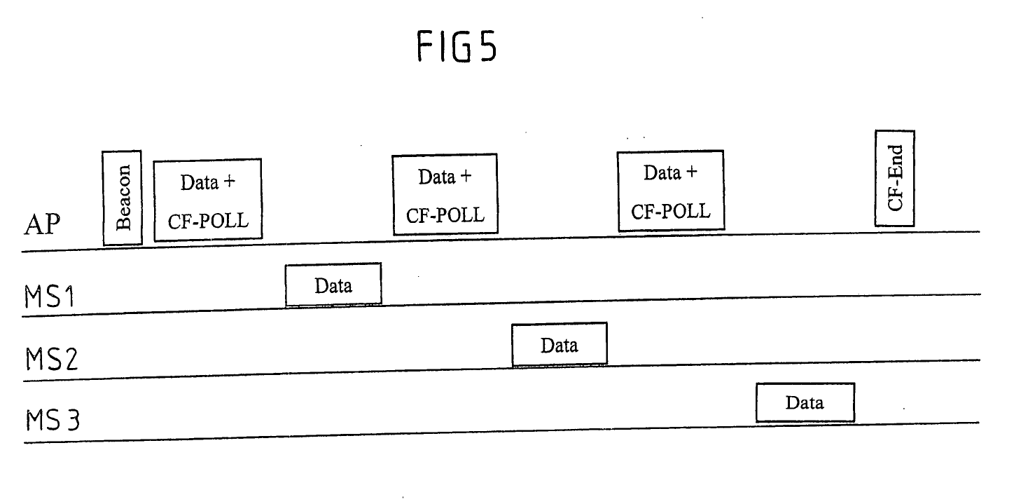

For better understanding, in FIG. 5 the data link between the access point AP1 and the three mobile stations MS1 to MS3 in the “first” transmission phase according to FIG. 2 is shown once again. It can be seen that the access point AP1 firstly passes data packets to the mobile station MS1. As soon as this process is completed, by means of a signal CF-Poll, data packets are requested from the mobile station MS1. Next, this process of the sending and “requesting” of data packets is repeated with the mobile stations MS2 and MS3. The “contention-free period” can for example be ended by a contention-free end signal CF-end.

The invention is not limited to the exemplary embodiments shown and described and is intended to include variations and modification included within the spirit and scope of the appended claims and their equivalents.

1-21. (canceled)

22. A method for operating a data link between a base station and one or more mobile stations, the method comprising:
indicating start of a transmission phase through emission of a beacon signal;
responsive to the beacon signal, configuring a transmission interface as a wireless interface between the base station and a mobile station for the transmission phase, and managing the transmission interface by the base station;
during the transmission phase, transmitting data packets between the base station and the mobile station;
preparing for a handover procedure by switching the mobile station into a monitoring phase, wherein the mobile station listens to radio traffic and seeks an alternative base station suitable for data packet transmission during the monitoring phase;
transmitting the data packets in every m^{th} transmission phase of the mobile station, where m is a natural number greater than one; and
after the data packet transmission has been effected, omitting the mobile station from the data packet transmission for at least one subsequent transmission phase.

23. The method of claim 22,
wherein the data packet transmission between the base station and the one or more mobile stations occurs during transmission phases, and
wherein the monitoring phase lies outside the transmission phases.

24. The method of claim 22, wherein the monitoring phase of the mobile station at least partly overlaps at least one omitted transmission phase, the mobile station being omitted from the data packet transmission with the base station during the at least one omitted transmission phase.

25. The method of claim 22, wherein the base station and the alternative base station operate with different transmission frequencies and beacon signals of the base station and the alternative base station are mutually asynchronous.

26. The method of claim 22, wherein beacon signals of the base station and the alternative base station are made equidistant.

27. The method of claim 22, wherein each mobile station effects a data packet transmission in every other transmission phase of the mobile station.

28. The method of claim 22, wherein if an alternative base station suitable for the data packet transmission is found during the preparing for the handover procedure, the mobile station sets up a parallel link with the alternative base station, the parallel link including a link between the mobile station and the base station and a link between the mobile station and the alternative base station, the parallel link being set up during time windows lying outside the transmission phases used for the data packet transfer between the mobile station and the base station.

29. The method of claim 28, wherein the time windows used for the parallel link include omitted transmission phases, the omitted transmission phases being transmission phases wherein the mobile station is omitted from the data packet transmission with the base station.

30. The method of claim 28, wherein the parallel link is an interim parallel link, and wherein after the link with the alternative base station has been set up, the parallel link with the base station is ended.

31. The method of claim 22, wherein the one or more mobile stations are assigned to even transmission phases used for the data packet transmission with the base station.

32. The method of claim 22, wherein the data packet transmission takes place under a WLAN standard and the base station is a WLAN access point.

33. The method of claim 22, wherein through the emission of the beacon signal a contention-free period is created for reserving the interface for a predetermined frequency range.

34. The method of claim 22, wherein an end of each transmission phase is indicated by emission of a contention-free end signal by the base station.

35. The method of claim 33, wherein between the transmission phases the interface in the predetermined frequency range is released for contention periods.

36. The method of claim 22, wherein a time interval between two consecutive beacon signals is at least twice as large as contention-free periods between the two consecutive beacon signals.

37. The method of claim 22, wherein duration of the monitoring phase of the mobile station is at least 1.5 times a time interval between two consecutive beacon signals.

38. The method of claim 22, wherein the data packets include real-time critical data streams and are transmitted during the data packet transmission.

39. The method of claim 22, wherein a time interval between two beacon signals is between 5 ms and 15 ms.

40. A base station for operating a data link with one or more mobile stations, comprising:
a control device configured to exchange data packets with the mobile stations within transmission phases;
means for assigning the transmission phases to the one or more mobile stations in such a manner that each mobile station performs data packet transmission in every m^{th} transmission phase, where m is a natural number greater than one, and
means for excluding each mobile station from the data packet transmission, after the data packet transmission has been effected, for at least one following transmission phase.

41. A mobile station for operating a data link with a base station, the mobile station comprising a mobile station control device, the mobile station control device further comprising:
means for exchanging data packets with the base station within transmission phases,
means for switching into a monitoring phase outside the transmission phases, the monitoring phase for listening to radio traffic and for seeking another base station suitable for data packet transmission,
means for performing the data packet transmission in every m^{th} transmission phase, where m is a natural number greater than one, and
means for omitting the data packet transmission during at least one transmission phase subsequent to the transmission phase including the data packet transmission.
